(19) United States
(12) Patent Application Publication
(10) Pub. No.: US 2016/0152284 A1
(43) Pub. Date: Jun. 2, 2016

(54) CAB ENCLOSURE FOR A MACHINE

(71) Applicant: Caterpillar Inc., Peoria, IL (US)

(72) Inventors: David A. Wiese, Peoria, IL (US); Thomas S. Ruffner, Washington, IL (US)

(73) Assignee: Caterpillar Inc., Peoria, IL (US)

(21) Appl. No.: 14/557,861

(22) Filed: Dec. 2, 2014

(51) Int. Cl. B62D 33/06; B62D 65/06; B60J 1/00; B62D 65/02

(52) U.S. Cl. CPC B62D 33/0617; B62D 65/02; B62D 65/06; B60J 1/006

(57) ABSTRACT

A cab enclosure for a machine includes a cab enclosure framework formed of a plurality of frame members. The cab enclosure framework defines a plurality of cab enclosure sides. The cab enclosure further includes a plurality of brackets secured to at least two frame members of a first cab enclosure side. The cab enclosure further includes a mounting frame having a substantially planar shelf portion and an attachment portion. The attachment portion is secured to the plurality of brackets and extends around the shelf portion. The cab enclosure further includes a panel including a peripheral portion secured to the shelf portion of the mounting frame.

### TECHNICAL FIELD

This disclosure pertains to cab enclosures for machines, and more particularly to cab enclosures having panels.

### BACKGROUND

Many large machines, such as trucks, dozers, loaders, excavators, motor graders, and the like, include a cab in which an operator rides. Such a cab typically includes a number of window panels, and the operator looks through the window panels at the surrounding environment or work site as the machine is operated. The window panels are ultimately supported by a framework of the cab.

U.S. Pat. No. 8,616,507 discloses assemblies for mounting a window panel to support frame members of a vehicle. Each assembly includes a strap that is wrapped around the outer periphery of a support frame member. A clamp is attached to the strap, and the window panel may be secured to the clamp. Such assemblies may be insufficient, however, to support a window panel of a large machine. Also, such assemblies extend around the entire outer periphery of a support frame member and therefore require a large amount of free space on the support frame member.

Thus, there remains a need for further developments relating to cab enclosures, and in particular, to cab enclosure having panels such as window panels.

### SUMMARY OF THE INVENTION

According to an aspect of this disclosure, a method is provided for securing a panel to a cab enclosure framework. The cab enclosure framework is formed of a plurality of frame members and defines a plurality of cab enclosure sides. The method includes securing a plurality of brackets to at least two frame members of a cab enclosure side. The method further includes securing a mounting frame to the plurality of brackets, the mounting frame including a substantially planar shelf portion. The method further includes securing a peripheral portion of the panel to the shelf portion of the mounting frame.

According to another aspect of this disclosure, a cab enclosure for a machine is provided. The cab enclosure includes a cab enclosure framework formed of a plurality of frame members, and defining a plurality of cab enclosure sides. The cab enclosure further includes a plurality of brackets secured to at least two frame members of a first cab enclosure side. The cab enclosure further includes a mounting frame having a substantially planar shelf portion and an attachment portion. The attachment portion is secured to the plurality of brackets and extends around the shelf portion. The cab enclosure further includes a panel including a peripheral portion secured to the shelf portion of the mounting frame.

According to yet another aspect of this disclosure, a machine is provided and includes a machine frame and a cab enclosure secured to the frame. The cab enclosure has a cab enclosure framework formed of a plurality of frame members. The cab enclosure framework defines a plurality of cab enclosure sides. A plurality of brackets is secured to at least two frame members of a first cab enclosure side. A mounting frame includes a substantially planar shelf portion and an attachment portion, and the attachment portion is secured to the plurality of brackets and extends around the shelf portion. A panel includes a peripheral portion that is secured to the shelf portion of the mounting frame.

### BRIEF DESCRIPTION OF THE DRAWINGS

FIGS. 1 and 2 are perspective views showing an articulated truck having a cab assembly.

FIG. 3 is an isometric exploded view showing a cab enclosure of the cab assembly, the cab enclosure including a front windshield assembly and a right-side window assembly.

FIG. 4 is an isometric view showing a bracket for securing the front windshield assembly and the right-side window assembly to a cab enclosure framework of the cab enclosure.

FIG. 5 is an isometric view showing brackets secured to frame members of the cab enclosure framework.

FIG. 6 is a partial cross-section view showing a bracket secured to a frame member, and a mounting frame secured to the bracket.

FIG. 7 is a view like FIG. 6, and showing a window panel secured to the mounting frame.

FIG. 8 is an isometric view showing the front windshield assembly secured to the cab enclosure framework, and with brackets secured to additional frame members of the cab enclosure framework.

FIG. 9 is a view like FIG. 7, and showing a further mounting frame secured to the mounting frame of FIG. 7.

FIG. 10 is a view like FIG. 9, and showing a further window panel secured to the further mounting frame of FIG. 9.

FIG. 11 is an isometric view showing the front windshield assembly and the right-side window assembly secured to the cab enclosure framework.

### DETAILED DESCRIPTION

This disclosure describes a method for securing a panel to a cab enclosure framework, a cab enclosure for a machine, and a machine having a cab enclosure. The method and cab enclosure described in this disclosure are generally applicable to a wide range of machines and panels. In order to illustrate the general principles of this disclosure, the figures depict and the following text describes window panels of a cab enclosure of an articulated truck. It will be appreciated, however, that the principles of this disclosure may be applicable to other types and configurations of machines and panels, as well. For example, this disclosure is also applicable to other types of trucks, as well as other machines, such as loaders, dozers, and the like; and to other types of panels, such as solid panels.

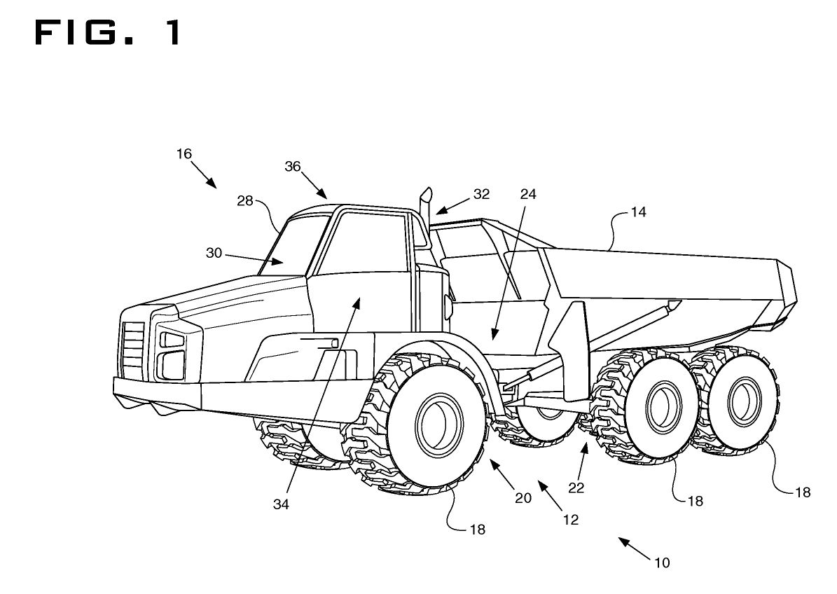

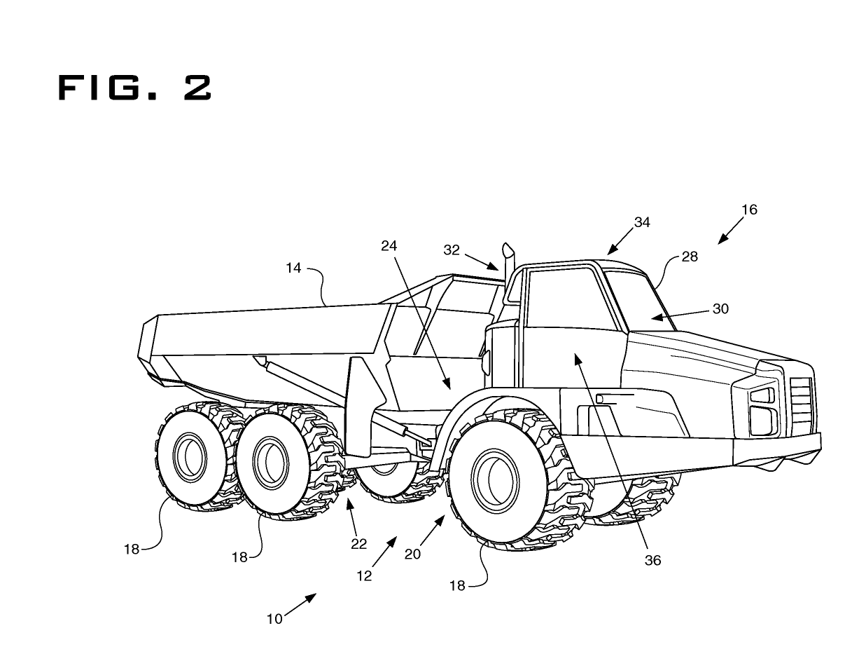

Referring to the figures and beginning with FIGS. 1 and 2, a machine 10 in the form of an articulated truck is shown and generally includes a frame or frame assembly 12, a body 14, a cab assembly 16, and a set of six ground engaging tires 18. The frame assembly 12 includes a front portion 20 and a rear portion 22, which are connected by an articulation joint 24. The cab assembly 16 is supported by the front portion 20 of the frame assembly 12, while the body 14 is supported by the rear portion 22. The body 14 is configured to receive a load of material, such as dirt. The machine 10 also includes a hoist system (not shown) for hoisting the body 14 relative to the frame assembly 12 in order to dump the load of material out of the body 14, as is generally known.

An operator station (not shown) is inside a cab enclosure 28 of the cab assembly 16 and provides a place for an operator to control the machine 10. For example, the operator station can include a seat for the operator to sit on, a steering wheel, accelerator and brake pedals, and various machine controls.

The construction of the cab enclosure 28 generally defines a plurality of cab enclosure sides. For example, and in the embodiment shown, the cab enclosure 28 defines four cab enclosure sides: a front side 30, a rear side 32, a left side 34, and a right side 36.

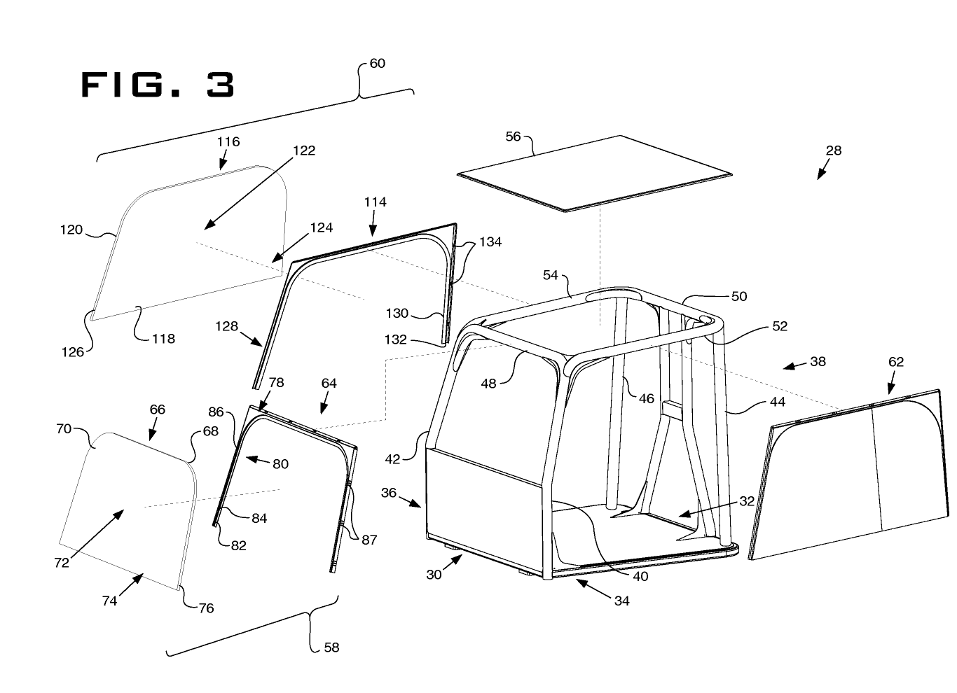

Referring next to FIG. 3, an exploded view of the cab enclosure 28 is shown. The cab enclosure 28 includes an underlying cab enclosure framework 38. For example, the cab enclosure framework 38 may provide a roll over protection structure (ROPS) or a falling object protection structure (FOPS), or both. The cab enclosure framework 38 is formed of a plurality of frame members, some or all of which may be tubular and have a circular or square cross-sectional shape, for example. As shown, the cab enclosure framework includes generally upright frame members 40, 42, 44, 46, and generally lateral frame members 48, 50, 52, 54.

The frame members of the cab enclosure framework 38 generally define the four cab enclosure sides. The front side 30 is generally defined by the upright frame members 40, 42 and the lateral frame member 48; the rear side 32 is generally defined by the upright frame members 44, 46 and the lateral frame member 50; the left side 34 is generally defined by the upright frame members 40, 44 and the lateral frame member 52; and the right side 36 is generally defined by the upright frame members 42, 46 and the lateral frame member 54.

The cab enclosure 28 includes a roof 56, a front windshield assembly 58, a right-side window assembly 60, and a left-side window and door assembly 62, all of which are supported by the cab enclosure framework 38. The front windshield assembly 58 is positioned on the front side 30 of the cab enclosure 28, the right-side window assembly 60 is positioned on the right side 36, and the left-side window and door assembly 62 is positioned on the left side 34.

Securing the front windshield assembly 58 and the right-side window assembly 60 to the cab enclosure framework 38 is now described, beginning with the front windshield assembly 58.

The front windshield assembly 58 generally includes a mounting frame 64 and a window panel 66. The mounting frame 64 is generally secured to the cab enclosure framework 38, and supports the window panel 66. During operation of the machine 10, an operator in the operator station can look out of the operator station through the window panel 66 of the front windshield assembly 58.

The window panel 66 includes an inner surface 68 that faces inwardly toward the operator station, and an outer surface 70 that faces outwardly away from the operator station. The window panel 66 generally includes a central portion 72 and a peripheral portion 74. The peripheral portion 74 extends around the central portion 72, and may be substantially planar. The window panel 66 also includes a peripheral surface 76 that extends in the thickness direction between the inner surface 68 and the outer surface 70.

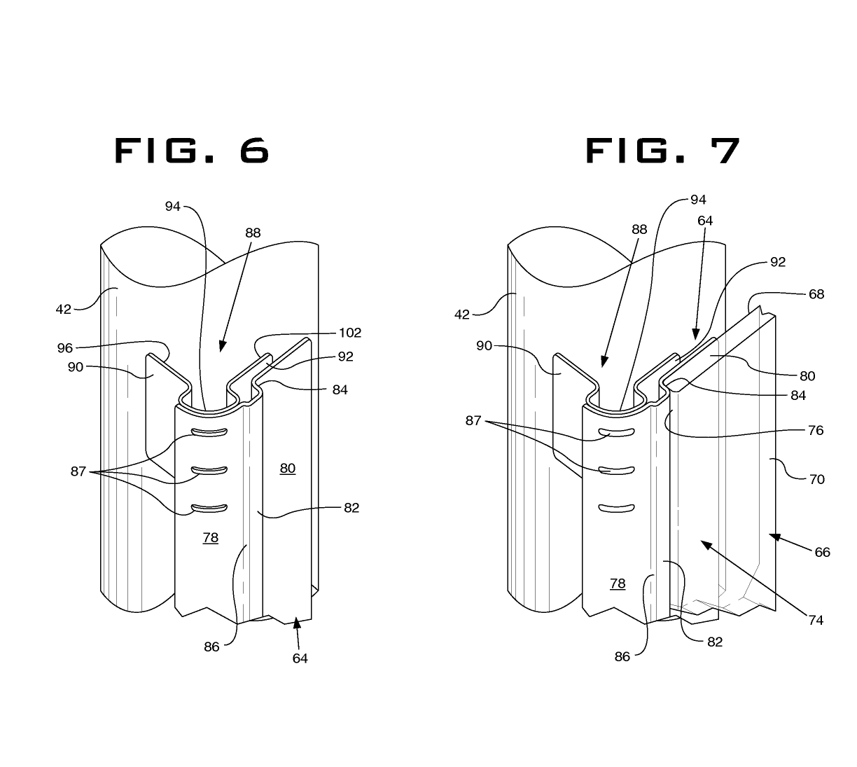

The mounting frame 64 is configured to be secured to the cab enclosure framework 38 and to support the window panel 66. The mounting frame 64 generally includes an attachment portion 78 and a substantially planar shelf portion 80, shown in more detail in FIGS. 6 and 7. The attachment portion 78 is for securing the mounting frame 64 to the cab enclosure framework 38, as will be described below. The shelf portion 80 is for receiving and supporting the window panel 66. The attachment portion 78 extends around the shelf portion 80. As shown, the attachment portion 78 and shelf portion 80 extend partially around the window panel 66 (around approximately three sides of the window panel 66). In other embodiments, the attachment portion 78 and shelf portion 80 may extend completely around the window panel 66.

Referring to FIGS. 6 and 7, the mounting frame 64 further includes a rib 82 disposed generally between the attachment portion 78 and the shelf portion 80. The rib 82 extends along the shelf portion 80 and the rib 82 can be shaped to protrude from the attachment portion 78 and the shelf portion 80 so as to define a first shoulder 84 and a second shoulder 86. The first shoulder 84 is generally between the rib 82 and the shelf portion 80, while the second shoulder 86 is generally between the rib 82 and the attachment portion 78.

The attachment portion 78 includes one or more slots 87. As will be described below, the slots 87 provide locations for welding the mounting frame 64 for securing it to the cab enclosure framework 38. The attachment portion 78 has a generally curved construction so as to include a curved shape in transverse cross section.

The mounting frame 64 is secured to the cab enclosure framework 38 via a plurality of brackets 88, which is shown in more detail in FIGS. 5-7. Generally, the brackets 88 are secured to the cab enclosure framework 38, and the mounting frame 64 is secured to the brackets 88.

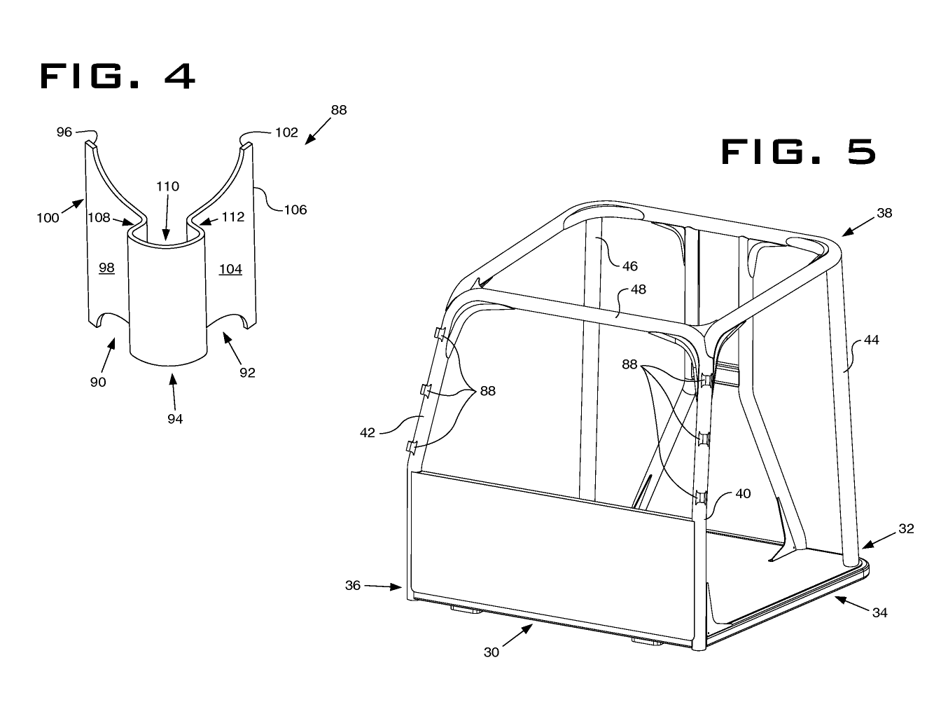

Referring to FIG. 4, each bracket 88 generally includes a first mounting leg 90, a second mounting leg 92, and a connecting portion 94 extending between the first mounting leg 90 and the second mounting leg 92.

The first mounting leg 90 and the second mounting leg 92 may have a generally similar construction. The first mounting leg 90 includes a confronting surface 96 and a back surface 98. The first mounting leg 90 also includes a free end 100 generally distal from the connecting portion 94. The second mounting leg 92 includes a confronting surface 102 and a back surface 104. The second mounting leg 92 also includes a free end 106 generally distal from the connecting portion. The first mounting leg 90 and the second mounting leg 92 may extend generally perpendicular to each other, and are connected by the connecting portion 94.

The connecting portion 94 generally includes three segments: a first segment 108, a second segment 110, and a third segment 112. The first segment 108 connects with the first mounting leg 90, the third segment 112 connects with the second mounting leg 92, and the second segment 110 connects the first segment 108 and the third segment 112. The connecting portion 94 has a generally curved construction between the first mounting leg 90 and the second mounting leg 92, so as to include a curved shape in transverse cross section. In particular, the curved shape of the connecting portion 94 may correspond with the shape of the second segment 110.

As shown in FIG. 5, brackets 88 can be secured to the frame members of the cab enclosure framework 38. In particular, for example, and for the front windshield assembly 58, a plurality of brackets 88 are secured to at least two of the frame members of the front side 30 (frame members 40, 42, and 48). For example, the brackets 88 can be secured to the two upright frame members 40, 42.

Securing each bracket 88 to a frame member can include securing the first mounting leg 90 and the second mounting leg 92 to the frame member. The first and second mounting legs 90, 92 can be secured to the same frame member. When a bracket 88 is secured to a frame member, the confronting surfaces 96, 102 of the first and second mounting legs 90, 92 are in confronting and contacting engagement with the frame member. The first mounting leg 90 and the second mounting leg 92 may be secured to a frame member by any appropriate means, such as welding or with a structural adhesive. Also, when a bracket 88 is secured to a frame member, the connecting portion 94 of the bracket 88 can be spaced from the frame member.

Each of the plurality of brackets 88 may be positioned at any suitable location on a frame member, and may be temporarily held in place relative to a frame member using a clamp. For example, a bracket 88 may be clamped to a frame member before the bracket 88 is fixedly secured to the frame member.

The brackets 88 may be secured to the frame members of the cab enclosure framework 38 before the mounting frame 64 is secured to the brackets 88.

Referring next to FIGS. 6 and 7, the mounting frame 64 is shown secured to the brackets 88. In particular, the attachment portion 78 of the mounting frame 64 is secured to the connecting portion 94 of each respective bracket 88. The mounting frame 64 may be secured to the brackets 88 by any appropriate means, such as welding or with a structural adhesive.

The curved shape of the attachment portion 78 of the mounting frame 64 generally corresponds with the curved shape of the connecting portion 94 of the bracket 88. Thereby, the curved shape of the attachment portion 78 overlays the curved shape of the connecting portion 94, such as for a substantial portion of the curved shape of the attachment portion 78.

The brackets 88 may be positioned such that the slot(s) 87 of the attachment portion 78 overlay a bracket 88 when the mounting frame 64 is secured to the brackets 88. The mounting frame 64 may be welded to a bracket 88 at the location of the slot(s) 87.

A panel, such as a planar section, can be secured to the mounting frame 64. For example, the window panel 66 can be secured to the mounting frame 64. For example, the window panel 66 may be secured to the mounting frame 64 after the mounting frame 64 is secured to the brackets 88. The peripheral portion 74 of the window panel 66 is secured to the shelf portion 80 of the mounting frame 64. In particular, the inner surface 68 of the peripheral portion 74 of the window panel 66 is brought into confronting relationship with the shelf portion 80 of the mounting frame 64. The window panel 66 may be oriented relative to the mounting frame 64 such that the peripheral surface 76 is positioned in facing relationship with the first shoulder 84 of the mounting frame 64. The window panel 66 may be secured to the mounting frame 64, as shown in FIG. 7, by any appropriate means, such as using an adhesive.

Securing the right-side window assembly 60 to the cab enclosure framework 38 is now described.

With reference to FIG. 3, the right-side window assembly 60 generally includes a mounting frame 114 and a window panel 116. The mounting frame 114 is generally secured to the cab enclosure framework 38, and supports the window panel 116. During operation of the machine 10, an operator in the operator station can look out of the operator station through the window panel 116 of the right-side window assembly 60.

The window panel 116 includes an inner surface 118 that faces inwardly toward the operator station, and an outer surface 120 that faces outwardly away from the operator station. The window panel 116 generally includes a central portion 122 and a peripheral portion 124, which extends around the central portion 122 and may be substantially planar. The window panel 116 also includes a peripheral surface 126 that extends in the thickness direction between the inner surface 118 and the outer surface 120.

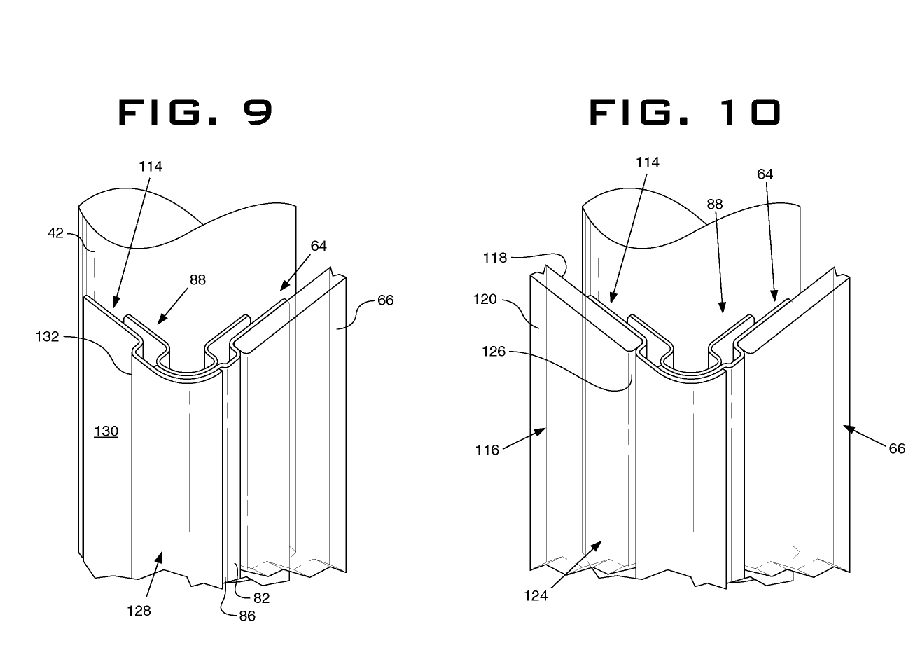

The mounting frame 114 is configured to be secured to the cab enclosure framework 38 and to support the window panel 116. With additional reference to FIGS. 9 and 10, the mounting frame 114 generally includes an attachment portion 128 and a substantially planar shelf portion 130. The attachment portion 128 is for securing the mounting frame 114 to the cab enclosure framework 38, as will be described below. The shelf portion 130 is for receiving and supporting the window panel 116 or other panel of a different material. The attachment portion 128 extends around the shelf portion 130. As shown, the attachment portion 128 and shelf portion 130 extend partially around the window panel 116 (around approximately three sides of the window panel 116). In other embodiments, the attachment portion 128 and shelf portion 130 may extend completely around the window panel 116.

The attachment portion 128 can protrude from the shelf portion 130 of the mounting frame 114 to define a shoulder 132. The shoulder 132 extends along the shelf portion 130.

The attachment portion 128 includes one or more slots 134, as shown in FIG. 3. As will be described below, the slots 134 provide locations for welding the mounting frame 114 for securing it to the cab enclosure framework 38. The attachment portion 128 has a generally curved construction so as to include a curved shape in transverse cross section.

The mounting frame 114 is secured to the cab enclosure framework 38 via a plurality of brackets 88 and via the mounting frame 64 of the front windshield assembly 58.

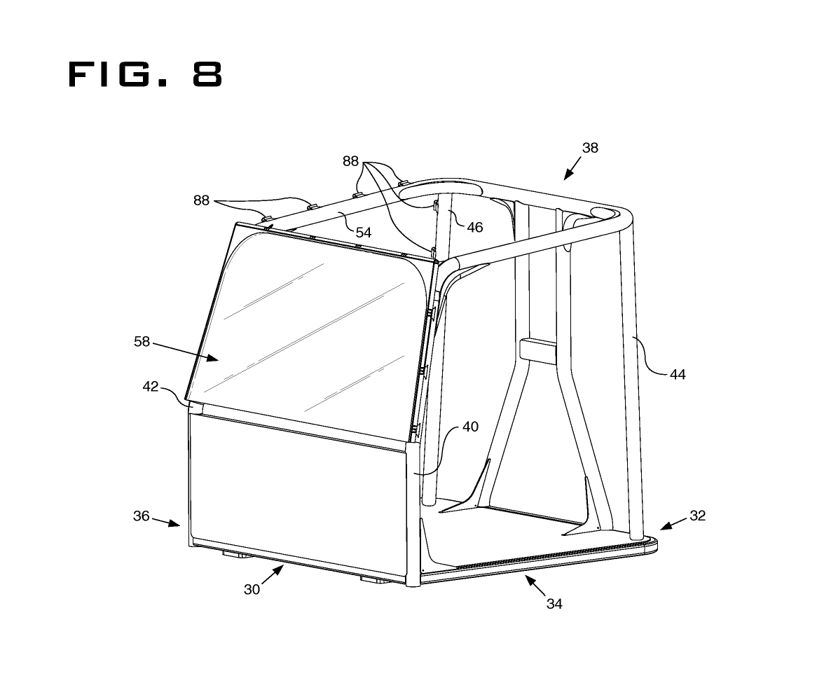

As shown in FIG. 8 and for the right-side window assembly 60, a plurality of brackets 88 are secured to at least one of the frame members of the right side 36 (frame members 42, 46, and 54). For example, the brackets 88 can be secured to the upright frame member 46. The brackets 88 may be secured to a frame member as discussed above.

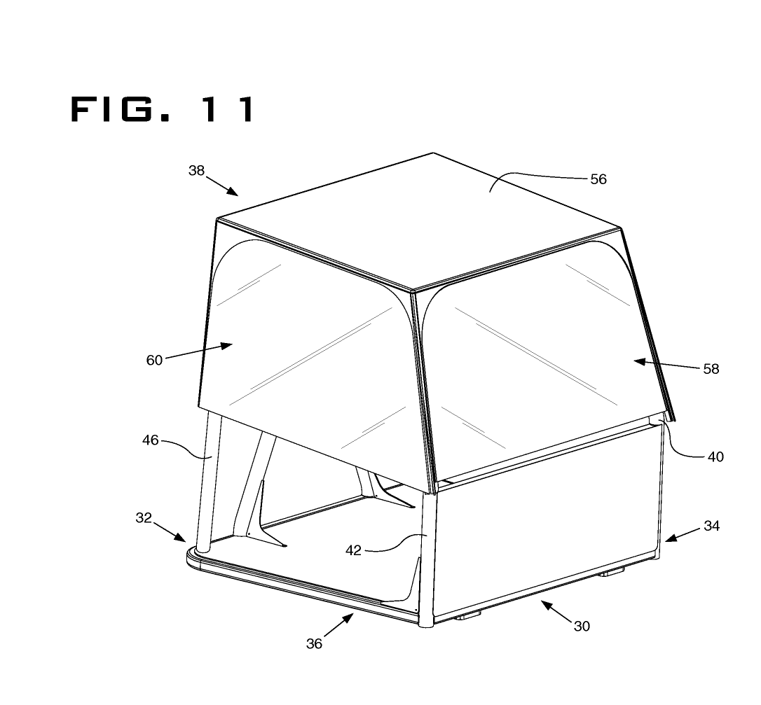

Referring next to FIGS. 9-11, the mounting frame 114 is secured to the brackets 88 and to the mounting frame 64 of the front windshield assembly 58. In particular, the attachment portion 128 of the mounting frame 114 is secured to the connecting portion 94 of each respective bracket 88, and to the mounting frame 64.

The curved shape of the attachment portion 128 generally corresponds with the curved shape of the attachment portion 78 of the mounting frame 64. Thereby, the curved shape of the attachment portion 128 overlays the curved shape of the attachment portion 78, such as for a substantial portion of the curved shape of the attachment portion 128.

The brackets 88 may be positioned such that the slot(s) 134 of the attachment portion 128 overlay a bracket 88 when the mounting frame 114 is secured to the brackets 88. The mounting frame 114 may be welded to a bracket 88 at the location of the slot(s) 134.

The window panel 116 is secured to the mounting frame 114. For example, the window panel 116 may be secured to the mounting frame 114 after the mounting frame 114 is secured to the brackets 88 and the mounting frame 64. In particular, the inner surface 118 of the peripheral portion 124 of the window panel 116 is brought into confronting relationship with the shelf portion 130 of the mounting frame 114. The peripheral portion 124 of the window panel 116 is secured to the shelf portion 130 of the mounting frame 114. The window panel 116 may be oriented relative to the mounting frame 114 such that the peripheral surface 126 is positioned in facing relationship with the shoulder 132 of the mounting frame 114. The window panel 116 may be secured to the mounting frame 114 by any appropriate means, such as using an adhesive.

### INDUSTRIAL APPLICABILITY

As described above, the present disclosure provides a method for securing a panel to a cab enclosure framework, a cab enclosure for a machine, and a related machine having such a cab enclosure. Panel assemblies may be secured to a cab enclosure framework via a plurality of brackets. In particular, brackets may be secured to frame members of the cab enclosure framework, and a mounting frame of a panel assembly may be secured to the frame member. A panel may be secured to the mounting frame. In addition, the mounting frame for one panel may be secured to another mounting frame for another panel.

Advantageously, the brackets may be secured to many types of frame members, such as those having square or circular tubular constructions. In addition, the brackets may be secured to outer aspects of the frame members, and are not accessible from the interior of the cab assembly. Moreover, the mounting frames provide planar shelf portions for receiving the panels, which provide good mounting surfaces for the panels, and encourage a solid attachment between the panel and the cab enclosure framework. Further, the brackets and the mounting frames allow panels to be supported in spaced relationship from the frame members of a cab enclosure framework.

What is claimed is:

1. A method for securing a panel to a cab enclosure framework formed of a plurality of frame members, the cab enclosure framework defining a plurality of cab enclosure sides, the method comprising:
securing a plurality of brackets to at least two frame members of a cab enclosure side,
securing a mounting frame to the plurality of brackets, the mounting frame including a substantially planar shelf portion, and
securing a peripheral portion of the panel to the shelf portion of the mounting frame.

2. The method of claim 1, wherein each bracket includes a first mounting leg and a second mounting leg, and
wherein securing each bracket includes securing the first mounting leg and the second mounting leg to the same respective frame member.

3. The method of claim 2, wherein securing the first mounting leg and the second mounting leg includes welding the first mounting leg and the second mounting leg.

4. The method of claim 2, where each bracket further includes a connecting portion extending between the first mounting leg and the second mounting leg, and
wherein securing the mounting frame includes securing the mounting frame to the connecting portion of each respective bracket.

5. The method of claim 1, wherein the mounting frame further includes a rib extending along the shelf portion, the rib defining a shoulder, and wherein the panel includes a peripheral surface, the method further comprising:
positioning the peripheral surface of the panel in facing relationship with the shoulder of the mounting frame.

6. The method of claim 1, wherein the mounting frame includes an attachment portion having at least one slot configured to overlay a bracket, and
wherein securing the mounting frame includes welding the mounting frame to a bracket at the location of the at least one slot.

7. The method of claim 1, further comprising:
clamping at least one bracket to each respective frame member before securing the at least one bracket to the respective frame member.

8. The method of claim 1, wherein the mounting frame is a first mounting frame, the plurality of brackets is a first plurality of brackets, and the cab enclosure side is a first cab enclosure side, the method further comprising:
securing a second plurality of brackets to at least one of the respective frame members of a second cab enclosure side,
securing a second mounting frame to the second plurality of brackets and to the first mounting frame, the second mounting frame including a substantially planar shelf portion, and
securing a peripheral portion of a second panel to the shelf portion of the second mounting frame.

9. A cab enclosure for a machine, comprising:
a cab enclosure framework formed of a plurality of frame members, the cab enclosure framework defining a plurality of cab enclosure sides,
a plurality of brackets secured to at least two frame members of a first cab enclosure side,
a mounting frame including a substantially planar shelf portion and an attachment portion, the attachment portion being secured to the plurality of brackets and extending around the shelf portion, and
a panel including a peripheral portion secured to the shelf portion of the mounting frame.

10. The cab enclosure of claim 9, the mounting frame further including a rib disposed between the shelf portion and the attachment portion, the rib defining a shoulder, and
the panel further including a peripheral surface, the peripheral surface facing the shoulder of the mounting frame.

11. The cab enclosure of claim 9, each bracket including a first mounting leg secured to a respective frame member, a second mounting leg secured to the same frame member, and a connecting portion extending between the first mounting leg and the second mounting leg.

12. The cab enclosure of claim 11, the connecting portion of each bracket being spaced from the respective frame member.

13. The cab enclosure of claim 11, the connecting portion of each bracket having a first curved shape in transverse cross section, and the attachment portion of the mounting frame having a second curved shape in transverse cross section, the second curved shape overlaying the first curved shape for a substantial portion of the second curved shape.

14. The cab enclosure of claim 11, wherein the panel is a window panel.

15. The cab enclosure of claim 9, the attachment portion of the mounting frame having at least one slot overlaying at least one bracket, the mounting frame being welded to the at least one bracket at the location of the at least one slot.

16. The cab enclosure of claim 9, wherein the mounting frame is a first mounting frame and the panel is a first panel, and further comprising:
a second mounting frame including a substantially planar shelf portion and an attachment portion, the attachment portion of the second mounting frame being secured to the attachment portion of the first mounting frame, and
a second panel including a peripheral portion secured to the shelf portion of the second mounting frame.

17. The cab enclosure of claim 16, wherein the plurality of brackets is a first plurality of brackets, and further comprising:
a second plurality of brackets, each of the second plurality of brackets being secured to at least one of the respective frame members of a second cab enclosure side, the second mounting frame being further secured to the second plurality of brackets.

18. The cab enclosure of claim 16, the first mounting frame further including a rib disposed between the shelf portion and the attachment portion, the rib defining a shoulder, and the first panel further including a peripheral surface facing the shoulder of the first mounting frame.

19. The cab enclosure of claim 18, the second mounting frame further including a shoulder between the shelf portion and the attachment portion, and the second panel further including a peripheral surface facing the shoulder of the second mounting frame.

20. A machine, comprising:
a machine frame, and
a cab enclosure secured to the frame,
the cab enclosure having a cab enclosure framework formed of a plurality of frame members, the cab enclosure framework defining a plurality of cab enclosure sides, a plurality of brackets secured to at least two frame members of a first cab enclosure side, a mounting frame including a substantially planar shelf portion and an attachment portion, the attachment portion being secured to the plurality of brackets and extending around the shelf portion, and a panel including a peripheral portion secured to the shelf portion of the mounting frame.
